(19) United States
(12) Patent Application Publication
(10) Pub. No.: US 2014/0250086 A1
(43) Pub. Date: Sep. 4, 2014

(54) WAN Gateway Optimization by Indicia Matching to Pre-cached Data Stream Apparatus, System, and Method of Operation

(71) Applicant: BARRACUDA NETWORKS, INC., Campbell, CA (US)

(72) Inventor: Fleming Shi, Cupertino, CA (US)

(73) Assignee: BARRACUDA NETWORKS, INC., Campbell, CA (US)

(21) Appl. No.: 13/916,186

(22) Filed: Jun. 12, 2013

Related U.S. Application Data
(60) Provisional application No. 61/771,919, filed on Mar. 3, 2013.

(51) Int. Cl. G06F 17/30; H04L 29/06; H04L 29/08

(52) U.S. Cl. CPC G06F 17/30156; H04L 67/2847; H04L 63/0442
USPC 707/692; 709/203; 713/153

(57) ABSTRACT

A network gateway coupled to a backup server on a wide area network which receives and de-duplicates binary objects. The backup server provides selected data segments of binary objects to the gateway to store into a prescient cache (p-cache) store. The network gateway optimizes network traffic by fulfilling a local client request from its local p-cache store instead of requiring further network traffic when it matches indicia of stored data segments stored in its p-cache store with indicia of a first segment of a binary object requested from and received from a remote server.

### RELATED APPLICATION

This non-provisional application claims priority from provisional application Ser. No. 61771919, filed 3 Mar. 2013 which is incorporated by reference in its entirety.

### BACKGROUND

It is known that conventional computer storage Backup apparatus deduplicate files by recognizing hashes of shards of binary objects. It is known that backup services operating off a wide area network use pattern recognition to de-dup data transfer over the Internet. It is known that large media files such as music and video are broken up into many standard sized segments which can each be recognized by a pattern such as a signature or a hash. It is known that a commercial backup service de-dup the storage of unaffiliated customers for improved scalability. It is known that applications which generate files commonly include a constant numerical or text value to identify a file form such as a file signature or “magic number” as an ad hoc standard. Magic numbers are common in programs across many operating systems. Magic numbers implement strongly typed data and are a form of in-band signaling to the controlling program that reads the data type(s) at program run-time. Many files have such constants that identify the contained data. Detecting such constants in files is a simple and effective way of distinguishing between many file formats and can yield further run-time information.

e.g. Compiled Java class files (bytecode) start with hex CAFEBABE. When compressed with Pack200 the bytes are changed to CAFEDOOD.

e.g. GIF image files have the ASCII code for “GIF89a” (47 49 46 38 39 61) or “GIF87a” (47 49 46 38 37 61).

e.g. JPEG image files begin with FF 08 and end with FF 09. JPEG/JFIF files contain the ASCII code for “JFIF” (4A 46 49 46) as a null terminated string. JPEG/Exif files contain the ASCII code for “Exif” (45 78 69 66) also as a null terminated string, followed by more metadata about the file.

e.g. Standard MIDI music files have the ASCII code for “MThd” (40 54 68 64) followed by more metadata.

Within this application we define a term “prescient cache” (pre-cache, p-cache) to mean a non-transitory store which contains data which has not recently been encountered but which the method of the invention anticipates will be requested from a remote server in the immediate future. In this application we define a term “indicia” to include identifying information which can be read from a binary object such as but not limited to: file signatures, magic numbers, file type, file name, date and time, file size, me hash, file properties, and other information found in headers of binary objects. In this application we use the term gateway to mean an apparatus positioned at the incidence of two or more networks. It may be viewed either as a point of entry or exit. The networks may be Local Area Networks, Wide Area Networks, or both. The disclosure refers to LAN gateways and WAN gateways and applies to either reference.

What is needed is an improvement in network optimization which does not depend on the cooperation of sources of large binary objects to recognize repeating patterns and encode references to previously transmitted blocks.

### BRIEF DESCRIPTION OF DRAWINGS

To further clarify the above and other advantages and features of the present invention, a more particular description of the invention will be rendered by reference to specific embodiments thereof which are illustrated in the appended drawing. It is appreciated that this drawing depicts only typical embodiments of the invention and are therefore not to be considered limiting of its scope. The invention will be described and explained with additional specificity and detail through the use of the accompanying drawing in which:

FIG. 1 is a block diagram of data flow through the components of the system.

### SUMMARY OF THE INVENTION

A plurality of data segments of a binary object are stored in a pre-cache store of a Wide Area Network (WAN) gateway in anticipation of demand. An indicia recognition circuit determines that a first data segment received from a target server in response to a request from a user client corresponds to a binary object stored entirely or in part in the pre-cache store. The WAN gateway fulfills the request from the user client without further network traffic with the target server. A backup server (b-server) receives and de-duplicates data segments of large binary objects from a plurality of backup clients (b-clients). The b-server distributes and stores data segments of a binary object entirely or in part in the pre-cache store of the WAN gateway.

A head of stream recognition circuit is coupled to a wide area network I local area network (WAN/LAN) gateway. A pre-cache is available to the WAN/LAN gateway stream recognition circuit which contains indicia of a backup data stream. Tails of data streams are cached at destination WAN gateways. Recipients are served by their local WAN gateway from the cache.

An integrated LAN gateway and cloud-based Backup Service optimizes Wide Area Network stream traffic. A registry is accumulated for upwardly trending backups of popular file fragments. Those most popular file fragments are pre-cached at a plurality of LAN gateway apparatus to which future streaming is postulated. The number of decryptions is controlled. A head of stream recognition indicia or pattern is provided to each LAN gateway. When a head of stream from a respectful source is recognized, the pre-cached tail is fulfilled to the destination. Records of the destinations are uploaded.

### DETAILED DISCLOSURE OF EMBODIMENTS

Reference will now be made to the drawing to describe various aspects of exemplary embodiments of the invention. It should be understood that the drawing is diagrammatic and schematic representations of such exemplary embodiments and, accordingly, is not limiting of the scope of the present invention, nor is the drawing necessarily drawn to scale.

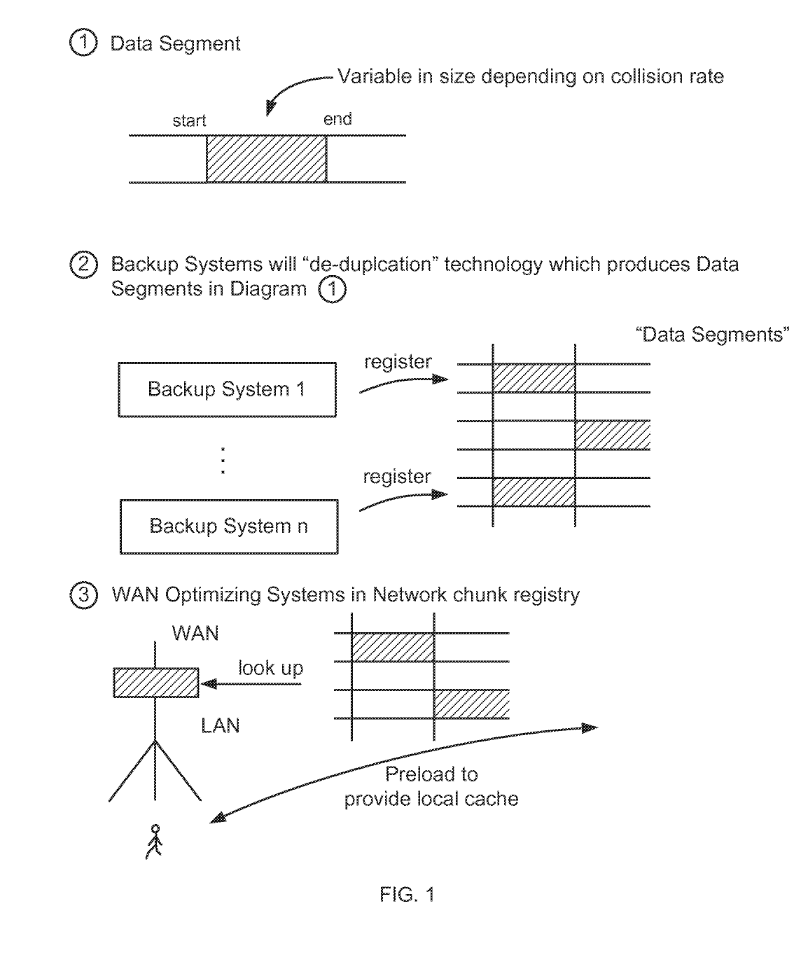

Referring to FIG. 1, a backup server (b-server) 300 is communicatively coupled to a Wide Area Network (WAN) gateway apparatus 500. The b-server is communicatively coupled to a plurality of backup clients (b-clients) 210-220. The b-server receives, de-duplicates, and stores binary objects such as files from the b-clients. In the process of de-duplicating, the b-server observes how widespread a binary object is and the rate at which it is proliferating among b-clients.

The WAN gateway 500 is directly coupled to a plurality of locally attached web client apparatuses 720-760 typically by a local area network. The WAN gateway receives requests from the web client apparatuses and transmits the requests to a plurality of web server 910-930 on a wide area network. Through means that are to be described in detail below, the backup server anticipates which binary objects it contains are likely to be requested by the web clients and transmits all or some of the data segments of the binary objects to the WAN gateway to be stored in a pre-cache store 530. Unlike a conventional cache store, the pre-cache store contains data segments which have not previously transited the WAN gateway. Unlike a conventional gateway the present invention contains an indicia match circuit 560 which is coupled to its network interfaces and to the pre-cache store. When a web server responds to a request, the indicia match circuit determines if the first received data segment of a response matches indicia of data segments stored in the pre-cache store. When there is no match, the gateway operates as a conventional gateway requesting each additional data segment of a data object and providing it in turn to the requesting web client apparatus. If the backup server has correctly anticipated a binary object to be requested by a web client, the indicia of the first received data segment will match the indicia of stored data segments. Upon this determination, the WAN gateway fulfills the remainder of the request from the pre-cache store 530 without consuming further wide area network resources.

One aspect of the invention is a system comprising a backup server communicatively coupled to a plurality of backup clients; the backup server further communicatively coupled by a wide area network to a Wide Area Network (WAN) gateway; the WAN gateway further communicatively coupled to a plurality of client apparatuses by a local network; the WAN gateway further communicatively coupled by the wide area network to a plurality of target servers, enabling client-server traffic between a client apparatus and a target server; wherein the WAN gateway comprises a pre-cache store and a circuit for matching indicia of a pre-cache stored data object with indicia of a received data object to confirm identity.

In an embodiment, the backup server determines which data objects to transmit for storage into pre-cache store based on the measure of de-duplication and the rate of growth of de-duplication of each data object. In an embodiment, the system further includes, a local administrator controlled list of respectful or disrespectful source IP addresses whose transmissions may be fulfilled from a pre-cache store accordingly.

In an embodiment, the pre-cache store contains indicia and encrypted data segments which are only decrypted when the first received data segment matches the indicia. in an embodiment, indicia are selected from a layer, a port, a source IP address, a checksum, a hash, a set of patterns, a set of digital signatures, or a timestamp.

In an embodiment the system further includes computer readable non-transitory storage containing instructions which when executed by a processor cause to store data segments which have been predicted by a backup server to be more likely to be requested on a wide area network, determine indicia characteristic of a data stream which include said stored data segments, receive a first data segment requested from a server on the wide area network by a locally attached client, determine a match of indicia of the received first data segment and the indicia of the stored data segments, and fulfill the request of the locally attached client by providing the stored data segments.

Another aspect of the invention is a method for operation of a backup server for wide area network (WAN) optimization, the method including: receiving de-duplicated data objects from a plurality of backup clients; anticipating which data objects are likely to be requested from servers, and transmitting a plurality of data segments of de-duplicated data objects to a WAN gateway.

In an embodiment, anticipating which data objects are likely to be requested from servers, comprises: determining the files with highest rate of growth in de-duplication. In an embodiment, anticipating which data objects are likely to be requested from servers, includes: determining the most frequently de-duplicated files received.

In an embodiment, the method also has the steps: determining indicia for a data object which can be compared with a first received data segment; and transmitting said indicia to a WAN gateway.

In an embodiment, transmitting a plurality of data segments of de-duplicated data objects to a WAN gateway comprises transmitting all but the first data segment of a data object to a WAN gateway.

In an embodiment, the method also has the steps: encrypting data segments prior to transmission to a WAN gateway; and enabling the WAN gateway to decrypt a data segment in fulfillment of a request from a client authorized to receive the data segment. In an embodiment, the method also has the steps: transmitting a list of servers respectful of intellectual property rights to a WAN gateway.

Another aspect of the invention is a method for operation of a Wide Area Network (WAN) gateway coupling a plurality of locally attached client apparatuses to remote servers on a wide area network, the method comprising: storing into pre-cache store a plurality of data segments of a binary object which is anticipated to be requested by its locally attached client apparatuses; determining when indicia of stored data segments stored in pre-cache store matches indicia of a first received data segment received from a remote server in response to a request from a locally attached client apparatus; fulfilling without additional network traffic a request from a locally attached client apparatus from the pre-cache store when the indicia of stored data segments matches the indicia of the first received data segment.

In an embodiment, the method also has the steps: determining if the request from a locally attached client apparatus is directed to a server respectful of intellectual property rights as a condition of fulfilling the client request. In an embodiment, fulfillment of the request from a locally attached client apparatus depends on authentication and validation by the remote server prior to fulfillment from the pre-cache store. In an embodiment, all segments except the first segment of a data object are stored in pre-cache store but indicia of the data object are stored in pre-cache store enabling network optimization of delivery of the second and following segments of the requested data object. In an embodiment, indicia of a first data segment received from a remote server which is not respectful of intellectual property rights is not compared with indicia of stored data segments stored in pre-cache store.

In an embodiment, the method also has the steps: decrypting the data segments stored in pre-cache store in encrypted form for fulfillment to a client which has been authenticated by a remote server; and counting down from a fixed limit of approved decryptions.

In an embodiment, indicia are selected from the group: the signatures, magic numbers, file type, file name, date and time, file size, file hash, and file properties.

One method embodiment provides that chunks of Backup data in the cloud are analyzed to build a cache registry which can identify the most-used *chunks* of data and pre-cache future WAN OPT devices. Some examples of the chunks: (Microsoft Office 201 0, iTunes music library etc.). Going into the future, the web filter which sees all web data in its path can contribute to this giant registry as well. In an embodiment, a computer storage backup server coupled to the computers served by the cloud/determines the most frequently encountered or highest volume data streams.

At a backup server, a registry of golden tuples is recorded which show the growth of segments and the patterns which characterize them.

The most popular tail segments are encrypted and distributed to a plurality of LAN gateway apparatus which we predict will receive the streams in the near future. A head of stream recognition rule is provided to each gateway. In one embodiment, recognition depends on a layer, a port, source IP address, a plurality of patterns for the segments at the start of the stream. According to local administrator control a list of respectful or disrespectful source IP may be checked to enable/disable the connection. (e.g. if itunes.com “okay,” if pirateisland.dirtistan “nope,” if unknown.noname your choice)

If the source is okay and the first m segments are recognized, then the pre-cached tail segments are decrypted and used for fulfillment. In an embodiment, a resettable limit on the number of decryptions is controlled. A record of the destinations is kept and uploaded.

Another aspect of the invention is an apparatus comprising a processor communicatively coupled to all of the following components: a plurality of WAN gateways coupled to a backup server, which provides indicia for head of stream and distributes associated tail of stream; a cache containing tail of stream data segments; and a head of stream recognition circuit configured with backup data segments at each WAN gateway.

Another aspect of the invention is a method at a WAN attached Backup Service stream traffic optimizing server: measuring the breadth and growth of stream type BLOBs in backups, predicting the location and popularity of future stream type BLOB backups, determining a pattern for each segment of a stream, distributing head recognition rules to LAN gateways in predicted locations of popularity, pre-caching n-r tail segments in encrypted format to said LAN gateways, limiting the number of decryptions of each tail segment, and receiving the destinations of tail segment fulfillment and renewing the number of allowed decryptions.

In an embodiment, segments may be variable in size depending on collision rate or of a standard size.

In an embodiment, file shards and file segments are equivalent in meaning. In an embodiment, a pre-cache refers to storage of binary content at a location before it has been first encountered at that location. A conventional cache refers to storage of binary content after its first use. In an embodiment, the data streams are ranked by the likelihood of being encountered and those most likely are selected for pre-caching. In an embodiment, recipients are authenticated and authorized to receive data streams. In an embodiment, a prediction is made to preload only those caches which are most likely to receive a data stream. In an embodiment, the tails of data streams are encrypted in storage and only decrypted for authorized and authenticated recipients. In an embodiment the number of decryptions is limited and resettable.

Conventional WAN optimization systems determine a pattern at a transmission point, and upon recognizing a repetition at the point of transmission, reuse a previously transmitted string corresponding to the pattern. The present invention can be easily distinguished by not depending on pattern recognition at transmission, and not depending on historically received transmissions at the destination. The tails of data streams are determined from backup systems and preloaded at LAN gateways to provide local cache along with indicia of their respective heads. It is unnecessary for the transmitting entity of the head of a data stream to be conscious or cooperative in this optimization. It can be appreciated that this invention can be easily distinguished from conventional methods because we get a head-start and do not have to learn as we encounter data transmissions on the fly.

Another aspect of the invention is an apparatus at a backup service to determine the most popular upward trending binary objects, to determine a head and a tail for upward trending binary objects, to distribute the tails to caches at postulated WAN gateway destinations, to distribute recognition indicia for the heads of the cached tails.

Another aspect of the invention is an apparatus coupled to a WAN gateway destination to receive and store indicia for heads of binary objects, to receive and cache tails of binary objects, to recognize receipt of a head of a binary objects based on stored indicia, to fulfill the distribution of a binary object to an authorized and authenticated destination from the tail cache.

Another aspect of the invention is a method at a Local Area Network (LAN) gateway having stored encrypted stream tails; recognizing a head of stream, by receiving a protocol, port, source IP address, comparing said protocol, port, source IP address with a list of disrespectful, respectful, and un categorized sources, terminating the connection depending on local administrator policies, receiving m segments of a stream, determining patterns in m segments of a stream, comparing patterns with patterns of pre-cached stream tails. The method further includes fulfilling a stream tail, comprising, recording the destination of a stream, decrypting the n-o segments of the stream, transmitting the n-o segments of the stream to the destination in lieu of WAN traffic, signaling successful delivery to the source of the stream, and when the number of allowed decryptions is exhausted, uploading the destinations and renewing the number of allowed decryptions.

Another aspect of the invention is a method at a WAN attached Backup Service stream traffic optimizing server which includes measuring the breadth and growth of stream type binary large objects (BLOBs) in backups, predicting the location and popularity of future stream type BLOB backups, determining a pattern for each segment of a stream, distributing head recognition rules to LAN gateways in predicted locations of popularity, pre-caching tail segments in encrypted format to said LAN gateways, limiting the number of decryptions of each tail segment, and receiving the destinations of tail segment fulfillment and renewing the number of allowed decryptions.

### CONCLUSION

A WAN gateway transfers a request for a data stream to a target server. Upon receiving a first data segment from the target server in response to the request, the WAN gateway compares indicia of the first data segment with a data stream in its pre-cache. When a data stream stored in the pre-cache of a WAN gateway matches the indicia of the first data segment received from a target server, the request is fulfilled from the pre-cache store of the WAN gateway which minimizes WAN traffic. A backup server (b-server) is communicatively coupled to a plurality of backup clients (b-clients). Large binary objects such as files are de-duplicated and stored in data segments in the b-server on a regular schedule. Some or all of a large binary object is distributed to and stored in a pre-cache store of a WAN gateway. A prescient cache (pre-cache, p-cache) can easily be distinguished from a conventional cache or conventional web cache which commonly means a store for previous responses or results. Conventional caches are generally managed to maintain the most recently used data. Applicant's p-cache has no dependence on most recently used or least recently used transactions on the gateway. Applicant's system determines the contents of p-cache from analysis of de-duplication statistics on his b-server. Applicant's p-cache can be easily distinguished from modifications to “look ahead” cache eviction operations in a graphics pipeline. Applicant's p-cache can be easily distinguished from network traffic to improve the “snappiness” of web browsing. In the latter case, network load and likelihood of congestion is increased rather than avoided.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A system comprising
a backup server communicatively coupled to a plurality of backup clients;
the backup server further communicatively coupled by a wide area network to a Wide Area Network (WAN) gateway;
the WAN gateway further communicatively coupled to a plurality of client apparatuses by a local network;
the WAN gateway further communicatively coupled by the wide area network to a plurality of target servers, enabling client-server traffic between. a client apparatus and a target server;
wherein the WAN gateway comprises a prescient cache (pre-cache) store and a circuit for matching indicia of a pre-cache stored data object with indicia of a received data object to confirm identity.

2. The system of claim 1 wherein the backup server determines which data objects to transmit for storage into pre-cache store based on the measure of de-duplication and the rate of growth of de-duplication of each data object.

3. The system of claim 1 further comprising a local administrator controlled list of respectful or disrespectful source IP addresses whose transmissions may be fulfilled. from a pre-cache store accordingly.

4. The system of claim 1 wherein the pre-cache store contains indicia and encrypted data segments which are only decrypted when the first received data segment matches the indicia.

5. The system of claim 1 wherein indicia are selected from a layer, a port, a source IP address, a checksum, a hash, a set of patterns, a set of digital signatures, a timestamp, file signatures, magic numbers, file type, file name, date and time, file size, file hash, and file properties.

6. The system of claim 1 further comprising
computer readable non-transitory storage containing instructions which when executed by a processor cause to store data segments which have been predicted by a backup server to be more likely to be requested on a wide area network, determine indicia characteristic of a data stream which include said stored data segments, receive a first data segment requested from a server on the wide area network by a locally attached client, determine a match of indicia of the received first data segment and the indicia of the stored data segments, and fulfill the request of the locally attached client by providing the stored data segments.

7. A method for operation of a backup server for wide area network (WAN) optimization, the method comprising:
receiving de-duplicated data objects from a plurality of backup clients;
anticipating which data objects are likely to be requested from servers, and
transmitting a plurality of data segments of de-duplicated data objects to a WAN gateway.

8. The method of claim 7 wherein anticipating which data objects are likely to be requested from servers, comprises:
determining the files with highest rate of growth in de-duplication;

9. The method of claim 7 wherein anticipating which data objects are likely to be requested from servers, comprises:
determining the most frequently de-duplicated files received.

10. The method. of claim 7 further comprising:
determining indicia for a data object which can be compared with a first received data segment; and
transmitting said indicia to a WAN gateway.

11. The method of claim 10 wherein transmitting a plurality of data segments of de-duplicated data objects to a WAN gateway comprises transmitting all but the first data segment of a data object to a WAN gateway.

12. The method of claim 7 further comprising:
encrypting data segments prior to transmission to a WAN gateway; and
enabling the WAN gateway to decrypt a data segment in fulfillment of a request from a client authorized to receive the data segment.

13. The method of claim 7 further comprising:
transmitting a list of servers respectful of intellectual property rights to a WAN gateway.

14. A method for operation of a Wide Area Network (WAN) gateway coupling a plurality of locally attached client apparatuses to remote servers on a wide area network, the method comprising:
storing into prescient cache (pre-cache) store a plurality of data segments of a binary object which is anticipated to be requested by its locally attached client apparatuses;
determining when indicia of stored data segments stored in pre-cache store matches indicia of a first received data segment received from a remote server in response to a request from a locally attached client apparatus;
fulfilling without additional network traffic a request from a locally attached client apparatus from the pre-cache store when the indicia of stored data segments matches the indicia of the first received data segment.

15. The method of claim 14 further comprising:
determining if the request from a locally attached client apparatus is directed to a server respectful of intellectual property rights as a condition of fulfilling the client request.

16. The method of claim 14 wherein fulfillment of the request from the locally attached client apparatus depends on authentication and validation by the remote server prior to fulfillment from the pre-cache store.

17. The method of claim 14 wherein all segments except the first segment of a data object are stored in pre-cache store but indicia of the data object are stored in pre-cache store enabling network optimization of delivery of the second and following segments of the requested data object.

18. The method of claim 14 wherein indicia of a first data segment received from a. remote server which is not respectful of intellectual property rights is not compared with indicia of stored data segments stored in pre-cache store.

19. The method of claim 14 further comprising:
decrypting the data segments stored in pre-cache store in encrypted form for fulfillment to a client which has been authenticated by a remote server; and counting down from a fixed limit of approved decryptions.

20. The method of claim 14 wherein indicia, are selected from the group file signatures, magic numbers, file type, file name, date and time, file size, file hash, and file properties.
